(19) United States
(12) Patent Application Publication
(10) Pub. No.: US 2006/0147810 A1
(43) Pub. Date: Jul. 6, 2006

(54) Holographic optical elements, devices and methods

(76) Inventor: Gene C. Koch, Bayville, NJ (US)

Correspondence Address: RONALD D. TRICE, 6412 BRANDON AVE., # 145, SPRINGFIELD, VA, 22150, US

(21) Appl. No.: 11/299,973

(22) Filed: Dec. 13, 2005

Related U.S. Application Data
(60) Provisional application No. 60/635,653, filed on Dec. 14, 2004.

(51) Int. Cl. G03H 1/02

(52) U.S. Cl. 430/1; 430/2; 359/3

(57) ABSTRACT

Holographic optical elements, devices and methods are disclosed. The holographic optical elements include calamitic materials. This is advantageous because the holographic medium in which the holographic image is formed is latent or very nearly latent, has little or no Rayleigh scattering, has high refractive index contrast, and is fabricated with mild post-processing conditions.

### RELATED APPLICATIONS

This application claims priority from, and incorporates by reference, U.S. Provisional application Ser. No. 60/635,653, filed Dec. 14, 2004.

### FIELD OF THE INVENTION

The present invention relates generally to holographic optical elements, devices and methods.

### BACKGROUND

Holographic optical elements with high diffractive efficiency are highly useful in many commercial and technical applications such as combiner optics for aircraft displays, passive beam steering elements for integrated optics, and as distributed Bragg reflectors for lasers. Such holographic optical elements may be fabricated with a number of photosensitive media currently used for recording holograms. One such material is dichromated gelatin. Unfortunately dichromated gelatin holograms are highly sensitivity to moisture and need to be rigorously protected from moisture including humidity and have lower service lifetimes. Additionally, dichromated gelatin is only sensitive to light in the blue or ultraviolet spectral regions.

Another such material is silver-halide sensitized gelatin (SHSG). Unlike dichromated gelatin, SHSG can have panchromatic sensitivity with the addition of sensitizer dyes. However, SHSG suffers from Rayleigh scattering, especially of blue light, which reduces its diffractive efficiency of holograms recorded in the material down to approximately 96%. This is insufficient for a number of optical applications including highly efficient plane wave mirrors. Also, the gelatin base of SHSG has a high sensitivity to atmospheric moisture like that of dichromated gelatin.

Another such material is photosensitive polymer (photopolymer). Photopolymer does not have the moisture and lifetime issues of dichromated gelatin and SHSG but does suffer from other disadvantages. For example, one disadvantage of photopolymers is they have a low refractive index contrast which means that relatively thick films must be used to achieve complete reflectance of light in a reflective hologram. Another disadvantage of photopolymers is they need to be post-processed either with enhancing agents or by heating. The postprocessing conditions may be incompatible with other components of an optical system that contains the hologram. Yet another disadvantage with photopolymers is that a significant percentage of the refractive index contrast is developed during the holographic exposure. This means that the film is beginning to reflect the light being used to expose it and the level of light exposure in the film begins to be non-uniform with depth. This can necessitate increasing the exposure dose in order to completely build up a hologram in the photopolymers. For a constant light intensity, this increases exposure times and exaggerates processing problems like vibration control.

Accordingly, there is a strong need in the art for a holographic medium which reduces or eliminate the above mention problems.

### SUMMARY OF THE INVENTION

An aspect of the invention is to provide a holographic optical element including a layer of a polymer material produced by polymerization of a thermotropic liquid crystalline monomer, wherein the polymer is comprised of microscopic zones of material with liquid crystalline order interspersed with microscopic zones of disordered material.

Another aspect of the invention is to provide a holographic optical element including a layer of a polymer material produced by polymerization of a thermotropic liquid crystalline monomer, wherein the polymer is comprised of microscopic zones of material with a first type of liquid crystalline phase interspersed with microscopic zones of material with a second type of liquid crystalline phase.

Another aspect of the invention is to provide a holographic recording material including a layer of photopolymerizable liquid crystalline material with the long molecular axes of the liquid crystalline material uniformly aligned.

Another aspect of the invention is to provide a process for recording a hologram including providing a film of liquid crystal material whose molecules are uniformly aligned is exposed to the interference pattern formed by an image beam and a reference beam, the areas of high light intensity in the interference pattern cause the liquid crystal material to be crosslinked, locking the liquid crystal structure into an immobile polymer matrix in those areas. After the interfering light beams are removed the film of liquid crystal material is heated above the phase transition temperature between the liquid crystal phase and a less ordered fluid phase. The heating causes the material in the previously uncrosslinked areas in the film to enter the less ordered fluid phase, and the film is flood exposed to light that crosslinks the previously uncrosslinked areas.

Another aspect of the invention is to provide a holographic optical element including a layer of polymer material formed from polymerization (e.g., photopolymerization) of a thermotropic liquid crystalline monomer. The layer of polymer material has microscopic zones that are ordered with a liquid crystalline order and microscopic zones that are less ordered than the microscopic zones that are ordered. The microscopic zones that are disordered and the microscopic zones that are ordered may form holographic fringe patterns. The holographic optical element may further include a polymeric binder. The polymeric binder may have a liquid crystalline structure or a non-liquid crystalline material. The holographic optical element may further include a low molecular weight diluent which may be an optically isotropic material or may have a liquid crystalline structure. The low molecular weight diluent may be thermally polymerizable and may be thermally crosslinked after exposure and development of holographic fringe patterns. The low molecular weight diluent may have a monotropic nematic to isotropic phase transition. The low molecular weight diluent may have a nematic to isotropic phase transition at a temperature below the temperature at which a light exposure is used to produce the holographic optical element. More of the low molecular weight diluent may be in the microscopic zones that are ordered than in the microscopic zones that are disordered. Alternatively, less of the low molecular weight diluent may be in the microscopic zones that are ordered than in the microscopic zones that are disordered. The holographic optical element may further include a substrate that supports the polymerized thermotropic liquid crystalline monomer or a cover sheet overlaying the layer of polymer material. The holographic optical element may further include an aligning layer used to align an extraordinary optical axis of the molecules of the thermotropic liquid crystalline monomer in a uniform direction. The aligning layer may be a rubbed polymer layer, a rubbed polyimide layer, a photoalignment layer, or a layer of material interposed between the polymerized thermotropic liquid crystalline monomer and a substrate or a cover sheet. The liquid crystalline order may be aligned homeotropically or homogenously relative to the layer of polymer material. The thermotropic liquid crystalline monomer that is polymerized may have the molecular structure B-S-A-S-B wherein A is a chromophore; S is a spacer; and B is a photocrosslinkable end group. The photocrosslinkable end group B may be selected from the group consisting of: 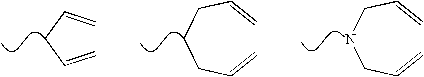
or may be selected from acrylate or methacrylate. The spacer groups S may independently be branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by F, —S—, —NH—, —NR—, —SiRR—, —CO—, —COO—, —OCO—, —COCO, —S—CO—, —CO—S—, —CH═CH—, —C≡C— such that O and S atoms are not directly linked to other O or S atoms. The A may be a chromophore of general formula —(Ar-Fl)ₙ-Ar— wherein Ar is an aromatic diradical or a heteroaromatic diradical bonded linearly or substantially linearly to adjoining diradicals, or a single bond; Fl is a 9,9-dialkyl substituted fluorene diradical joined to adjoining diradicals at the 2 and 7 positions; and the Ar and Fl diradicals are chosen independently in each of the n subunits of the chromophore. The thermotropic liquid crystalline monomer that is polymerized may have a birefringence value (Δn) greater than 0.2, or greater than 0.5. The microscopic zones that are disordered and microscopic zones that are ordered may include microscopic planes of alternating high and low refractive index. The layer of polymer material may be a holographic optical element that is a plane wave hologram. The microscopic planes of alternating high and low refractive index may be parallel or perpendicular to the layer of polymer material. The microscopic planes of alternating high and low refractive index may form an angle with the layer of polymer material that is >0° and <90°. The liquid crystalline order may be a smectic order and the microscopic zones that are less ordered may have a nematic order.

Another aspect of the invention is to provide a holographic optical element including a layer of polymer material formed from polymerization of a thermotropic liquid crystalline monomer. The layer of polymer material includes microscopic zones of material with a first type of liquid crystalline phase interspersed with microscopic zones of material with a second type of liquid crystalline phase. The first type of liquid crystalline phase may be a smectic phase. The second type of liquid crystalline phase may be a nematic phase. The holographic optical element may further include a low molecular weight diluent. The low molecular weight diluent may be an optically isotropic material, may have a liquid crystalline structure, may be more highly concentrated in the microscopic zones with the first type of liquid crystalline phase than in the zones with the second type of liquid crystalline phase, may have a monotropic liquid crystal to isotropic phase transition, and/or may be thermally polymerizable. Thermally crosslinking the low molecular weight diluent may be performed after exposure and development of holographic fringe patterns.

Another aspect of the invention is to provide a holographic recording material including a layer of photopolymerizable liquid crystalline material, the layer of photopolymerizable liquid crystalline material having long molecular axes that are substantially uniformly aligned. The photopolymerizable liquid crystalline material may have a nematic phase or a smectic phase. The holographic recording material may further include a polymeric binder. The polymeric binder may have a liquid crystalline structure or a non-liquid crystalline structure. The holographic recording material may further include a low molecular weight diluent. The low molecular weight diluent may be an optically isotropic material or a liquid crystalline material. The low molecular weight diluent may be a thermally crosslinkable material. The low molecular weight diluent may be a material having a monotropic liquid crystal to isotropic phase transition. The low molecular weight diluent may have a liquid crystalline to isotropic phase transition at a temperature below a temperature at which light exposure is used to produce the holographic optical element. The holographic recording material may further include a polymerization initiator such as a photoinitiator. The holographic recording material may further include a photosensitizing dye.

Another aspect of the invention is to provide a process for recording a hologram including providing a film of liquid crystal material having uniformly aligned molecules, exposing the film of liquid crystal material to an interference pattern of light such that areas corresponding to high light intensity in the interference pattern cause the liquid crystal material to crosslink such that a liquid crystal structure is locked into an immobile polymer matrix in the areas corresponding to high light intensity while leaving areas outside the areas corresponding to high light intensity substantially uncrosslinked, causing the areas outside the areas corresponding to high light intensity of the film of liquid crystal material into a less ordered fluid phase, and crosslinking the film of liquid crystal material in the areas outside the areas corresponding to high light intensity. The causing the areas outside the areas corresponding to high light intensity of the film of liquid crystal material into the less ordered fluid phase may be performed by heating the film of liquid crystal material above a phase transition temperature between a liquid crystal phase of the liquid crystal material and the less ordered fluid phase of the liquid crystal material. The crosslinking the film of liquid crystal material may be performed by light exposure. The film of liquid crystal material may be supported by a transparent substrate. Molecules of the film of liquid crystal material may be uniformly aligned by an aligning layer. The aligning layer may be a layer interposed between the liquid crystal film and a transparent substrate, a rubbed polymer layer, a rubbed polyimide layer or a photoalignment layer. The aligning layer may be a layer interposed between the film of liquid crystal material and an overlaid transparent cover sheet. The film of liquid crystal material is overlaid with a transparent cover sheet. The liquid crystal material may be a nematic liquid crystal or a smectic liquid crystal. The less ordered fluid phase may be a nematic phase or an isotropic liquid phase. The film of liquid crystal may further include a polymeric binder. The polymeric binder may have a liquid crystalline structure or a non-liquid crystalline structure. The film of liquid crystal material may include a low molecular weight diluent. The low molecular weight diluent may be an optically isotropic material or may have a liquid crystalline structure. The low molecular weight diluent may be thermally crosslinkable that may be thermally crosslinked after exposing the film of liquid crystal material to the interference pattern. The low molecular weight diluent may have a monotropic liquid crystal to isotropic transition. The low molecular weight diluent may have a liquid crystal to isotropic transition at a temperature below a temperature at which light exposure is used to produce the holographic optical element. The low molecular weight diluent may migrate from the areas corresponding to high light intensity into areas outside the areas corresponding to high light intensity during the exposing the film of liquid crystal material to the interference pattern. The migration of the low molecular weight diluent may lowers the refractive index of areas of the film of liquid crystal material into which the low molecular weight diluent migrates. The migration of the low molecular weight diluent may lower a refractive index of the areas outside the areas corresponding to high light intensity such a refractive index of the areas outside the areas corresponding to high light intensity is equal to an ordinary refractive index of the liquid crystal material that is crosslinked while exposing the film of liquid crystal material to an interference pattern. The uniform alignment of the film of liquid crystal material may be homogenous alignment, may be homogenous alignment in the plane of the film, or may be homeotropic alignment. The film of liquid crystal material that is polymerized may the molecular structure B-S-A-S-B wherein A is a chromophore, S is a spacer and B is a photocrosslinkable end group. The photocrosslinkable end group B may be selected from the group consisting of: 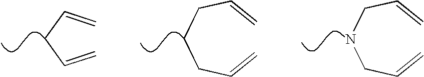
or may be selected from an acrylate or methacrylate. The spacer groups S may independently be branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, CH═CH—, —C≡C— such that O and S atoms are not directly linked to other O or S atoms. The A may be a chromophore of general formula —(Ar-Fl)ₙ-Ar— wherein Ar is an aromatic diradical or a heteroaromatic diradical bonded linearly or substantially linearly to adjoining diradicals, or a single bond, Fl is a 9,9-dialkyl substituted fluorene diradical joined to adjoining diradicals at the 2 and 7 positions, and the Ar and Fl diradicals may be chosen independently in each of the n subunits of the chromophore. The film of liquid crystal material that is polymerized may have a birefringence value (Δn) greater than 0.2, or advantageously greater than 0.5. The reference beam that is interfered with the image beam may be a plane wave beam. The image beam that is interfered with the reference beam may be a plane wave beam. The interference pattern may be formed by an image beam and a reference beam.

### BRIEF DESCRIPTION OF THE DRAWINGS

The invention will be described in detail with reference to the following drawings in which like reference numerals refer to like elements wherein:

FIG. 1 illustrates an exemplary holographic film that includes of a calamitic reactive mesogen material layer;

FIG. 2 illustrates another exemplary holographic film that includes a cover sheet;

FIG. 3 illustrates an apparatus used to record reflection holograms in a holographic medium;

FIG. 4. illustrates a plane wave hologram or holographic mirror produced by replacing the object in FIG. 3 with a plane mirror;

FIG. 5a illustrates a small volume of the calamitic layer with reactive mesogen molecules in the holographic film;

FIG. 5b illustrates the same small volume after sufficient exposure to cause the reactive mesogen to photocrosslink;

FIG. 5c illustrates the first step in the post-processing of the exposed holographic film;

FIG. 5d illustrates fixing the holographic image in the holographic film;

FIG. 6 illustrates the alignment of the molecular cores of a crosslinked reactive mesogen in a holographic film of the invention that has been used to record a plane wave hologram;

FIG. 7a illustrates a holographic reflector that reflects only one polarization of light; and

FIG. 7b illustrates the interfering light beams of FIG. 7a create an interference pattern in the calamitic layer.

### DETAILED DESCRIPTION

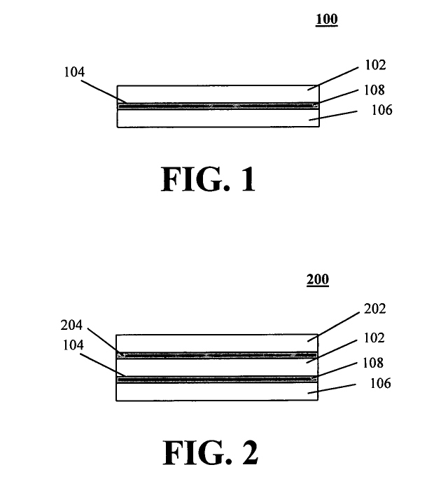

FIG. 1 illustrates an exemplary holographic film 100 that includes of a calamitic (e.g., nematic, smectic or hexatic) reactive mesogen material layer 102. The calamitic layer 102 is birefringent, preferably highly birefringent. The reactive mesogen may be a liquid crystalline material that is crosslinkable into a polymer matrix. As a part of the holographic film 100, a means is provided to align long axes of the molecules of the calamitic material layer 102 uniformly parallel to each other and to a surface 104 of a substrate 106 on which the calamitic layer 102 is formed (e.g., homogenous alignment). This aligning means may be an aligning polymer layer 108 interposed between substrate 106 and layer 102 that anisotropically interacts with the calamitic molecules of layer 102 to cause the uniform alignment. The anisotropy of the aligning polymer layer 108 may be caused by unidirectional rubbing of polyimide polymer which may comprise the aligning polymer layer 108 as is well known in the art. Alternatively the aligning polymer layer 108 may be comprised of a photoalignment material in which the alignment anisotropy is induced by exposure to plane polarized light. The use of polymer-bound cinnamic acid esters as such a photoalignment layer is described in Jpn. J. Appl. Physics, 31(1992), p. 2155, which is incorporated herein by reference. The homogenous alignment may also be caused by an underlying aligned layer of polymer with uniform calamitic liquid crystalline order. Other homogenous alignment means may be used as are well known in the art.

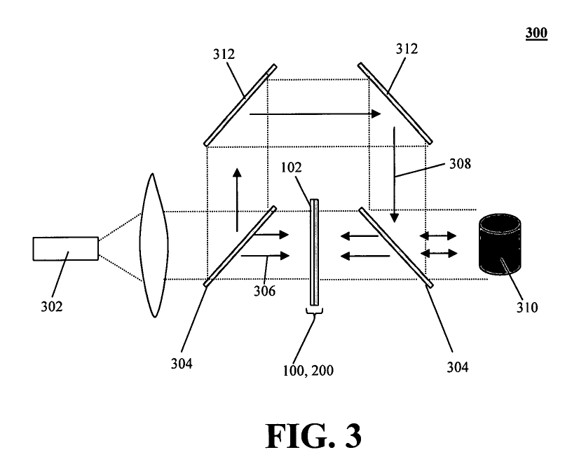

FIG. 2 illustrates another exemplary holographic film 200 that includes a cover sheet 202. The cover sheet 202 may be provided that also has an aligning means similar to that of substrate 106. In this case, the cover sheet 202 has a polymer layer 204 that induces homogenous alignment in the calamitic layer 102. An advantage may be found in such an exemplary holographic film 200 of FIG. 2, in that the molecules of the reactive mesogen used do not align with their long molecular axes parallel to a free air surface 110 in embodiment 100. In such a case, the molecular long axis alignment would splay upwards as one traversed upwards through the calamitic layer 102 from surface 104 to the free, air surface 110. It is known that different reactive mesogen compounds have different characteristic angles ranging from 0° to 90° from the normal at the free air surface.

The calamitic layer 102 may be in a truly fluid liquid crystal phase or it may be a liquid crystalline glass. Such a liquid crystalline glass may be formed by supercooling a liquid crystal material rapidly below its crystalline solid to liquid crystal phase transition temperature.

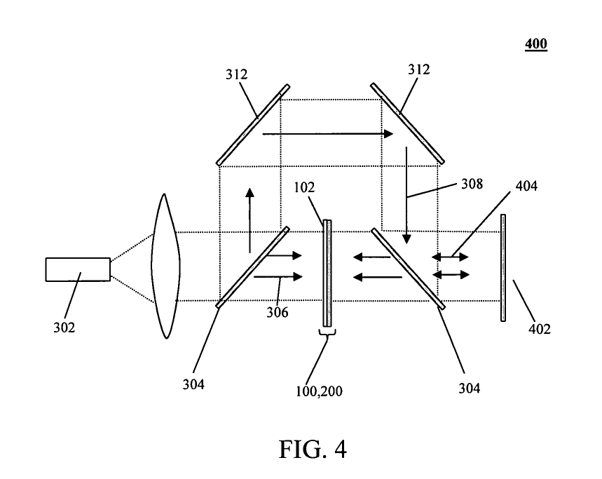

FIG. 3 illustrates an apparatus used to record reflection holograms in a holographic medium. A hologram is formed by the interference of object and reference beams of light in a holographic film such as the holographic films 100, 200 of FIG. 1 and FIG. 2. The hologram is formed when light from a source 302 of sufficient coherence (e.g., a laser) is split into two beams by a beam splitter 304. One beam 306 impinges directly onto the holographic film 100. The second beam 308 is redirected so as to reflect off an object 310 whose image is to be recorded to the rear of the holographic film 100. The two beams of light interfere one with the other in the holographic film 100, 200. The interference creates a fringe pattern of high and low light intensity in the calamitic layer 102. The apparatus of FIG. 3, as well as many other well known optical configurations are used to record reflection as well as transmission holograms and may be used with the holographic films disclosed herein. However, the holographic films disclosed herein may be used with any suitable holographic forming apparatus.

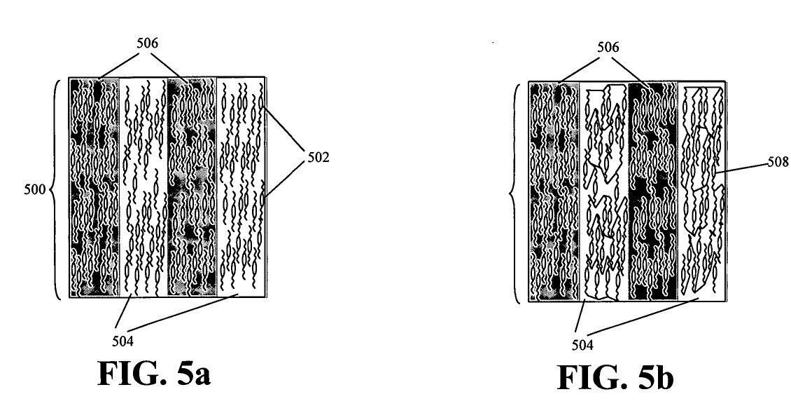

FIG. 4. illustrates a plane wave hologram or holographic mirror produced by replacing the object 310 in FIG. 3 with a plane mirror. A mirror 402 reflects a plane wave beam of light 404 propagating normal to the plane of the holographic film 100, 200 that interferes with reference beam 304 plane waves in the holographic film 100, 200. The light interference fringes that result lie along a series of planes parallel with the plane of the holographic film 100, 200 and spaced λ/2 apart, where λ is the wavelength of light source 302.

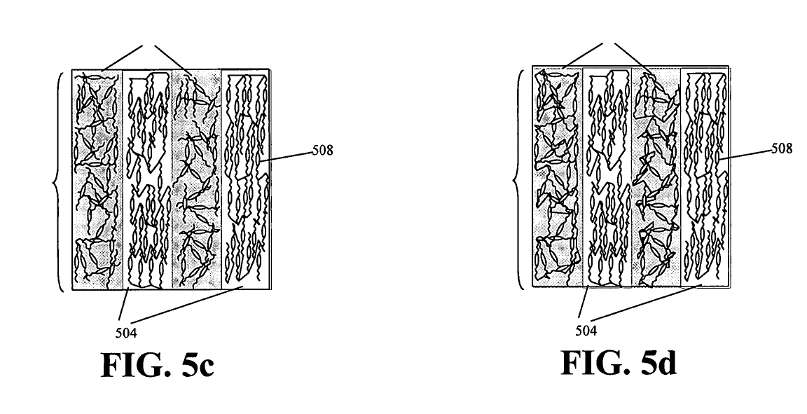

FIG. 5a illustrates a small volume 500 of the calamitic layer 102 with reactive mesogen molecules 502 in the holographic film 100. Unshaded areas 504 represent areas of high light intensity while shaded areas 506 represent areas of low light intensity in the interference fringes.

FIG. 5b illustrates the same small volume 500 after sufficient exposure to cause the reactive mesogen to photocrosslink. It can now be seen that the reactive mesogen in the high intensity light areas (unshaded areas 504) now has chemically crosslinked into a polymer matrix 508, while the molecules 502 in areas of low light intensity (shaded areas 506) remain substantially uncrosslinked.

At this time the refractive index modulated image of the fringes in the calamitic layer 102 may already exist to some extent or it may be latent. It will at least partially exist if the crosslinking of the liquid crystal molecules alters the refractive index of the material. This likely to be true if there is shrinkage of the liquid crystal material as it is crosslinked. This provides advantages in terms of exposure time and possibly holographic efficiency if the fringes are latent during and after this exposure. Thus the use of a reactive mesogen that substantially does not shrink upon photocrosslinking is advantageous.

FIG. 5c illustrates the first step in the post-processing of the exposed holographic film 100, 200. The film is heated above some transition temperature at which the calamitic reactive mesogen material in the calamitic layer 102 undergoes a phase transition to a less ordered fluid phase. For example, if the reactive mesogen in the calamitic layer 102 begins the exposure process in the nematic liquid crystalline phase, the phase transition may result in its entering the isotropic (completely disordered) liquid phase. This is the example portrayed in FIGS. 5a-d. However, if the reactive mesogen of the calamitic layer 102 begins the exposure process in the smectic A phase, it may enter the nematic or alternatively the isotropic phase upon heating. The result is that a sharp decrease in refractive index occurs as the material passes through the phase transition temperature. Since the calamitic order of the molecular cores of the reactive mesogen is substantially locked-in in the crosslinked polymer 508, even above the phase transition temperature the refractive index of areas 506 exposed to high light intensity remains substantially unchanged. Thus the interference fringes are imaged by refractive index modulation in the calamitic layer 102.

FIG. 5d illustrates fixing the holographic image in the holographic film 100, 200. This is accomplished by flood exposing the holographic film 100, 200 to light of some wavelength that induces crosslinking of the molecules in regions 506 while maintaining the holographic film 100, 200 above the phase transition temperature. In this way these molecules are now converted into a polymer matrix that locks in the less ordered phase structure even when the temperature of film 100 is reduced below the phase transition temperature.

Any reactive mesogen may be used in the holographic film 100, 200 so long as they have a phase transition to a lower refractive index phase at an elevated temperature reasonably accessible above the exposure temperature. However, in many applications it may be advantageous if that the phase transition temperature not be so high as to be incompatible with other components in an optical system in which the hologram is a component or with an easily achieved manufacturing process. For many applications a 50° to 80° phase transition temperature is optimal and compatible with exposure at room temperature. If the phase transition temperature is too close to the exposure temperature, for example 10° C. or less above the exposure temperature, the calamitic phase in which the holographic exposure is made is likely to have lower order parameter (poorer parallel alignment between molecules) than would otherwise be the case and therefore refractive index contrast would be compromised.

Exemplary reactive mesogen materials have the structure: 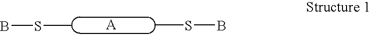
where A is the rigid rod-like or lathe-like core of the molecule, S is a flexible spacer such as an alkylene diradical, or an alkylene diradical in which a methylene group is replaced with a heteroatom such as O, S, or NR where R is an alkyl group, and B is a photoactivated crosslinking group such as an ethylenically unsaturated group. The spacers S are attached to the rigid molecular core at its ends. Substituent groups that may be used as crosslinking groups in the above structure include, but are not limited to unconjugated dienes, acrylates, methacrylates, and vinyl ethers. Non-ethylenic crosslinking groups such as oxetanes and epoxies may also be used as well so long as the crosslinking polymerization is photoinitiated.

Unconjugated dienes, for example 1,4-pentadien-3-yl groups, are useful as photocrosslinking groups in this application. This is because these materials show very little shrinkage upon crosslinking. This is thought to be because of the formation of rigid alicyclic rings as a result of the crosslinking reaction. Reactive mesogens of this type are described in A. E. A. Contoret, et al., Chem. Mater. 2002, 1477-87 and published U.S. Patent Applications 2003/0119936 and 2003/0099862, which are incorporated herein by reference. As explained above, because shrinkage in the material is generally accompanied by an increase in refractive index, shrinkage upon photocrosslinking may be undesirable because it would destroy the latency of the holographic image.

Materials of Structure 1 are not the only reactive mesogens that may be used in the invention. For example, reactive mesogens with Structures 2, 3, and 4 may be used.

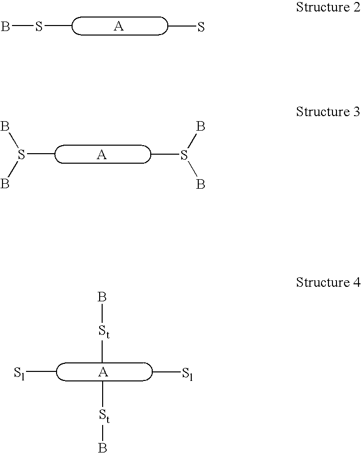

In these structures A, B, and S have the same meanings as in Structure 1. Structure 2 has only a single crosslinking group terminating one of its two terminal spacers. Many nematic reactive mesogens of this type where B is an acrylic or methacrylic group are known to undergo a phase change to a smectic phase on photopolymerization. This is disadvantageous in that it may remove the latency of the hologram during exposure, but may be advantageous in some applications. Structure 3 contains four crosslinking groups. This will yield a more highly crosslinked structure upon photopolymerization. In Structure 4 two spacers Sₜ that extend transversely from the long axis of the molecular core are terminated by the crosslinking groups B. Two other flexible tail groups Sₗ extend from the ends of the molecular core and are required to yield calamitic behavior. In this molecule A should be relatively long and Sₗ should be longer than Sₜ to allow the material to be liquid crystalline. Materials containing one or more of Structures 1, 2, 3, 4, and other reactive mesogen structures may be advantageously used to prepare mixtures with optimized properties for use in holographic films of the invention.

One factor in increasing the diffractive efficiency achievable by a holographic medium is refractive index contrast. In the films of the invention the refractive index contrast is determined by the birefringence, Δn=nₑ−nₒ, of the reactive mesogen. Therefore, materials with very high birefringence values should give the best results. Materials particularly useful for this application are diene substituted aryl fluorenes of the types described in U.S. Patent Application Ser. No. 60/563,343, which is incorporated herein by reference. An example of which is Compound 1 below. 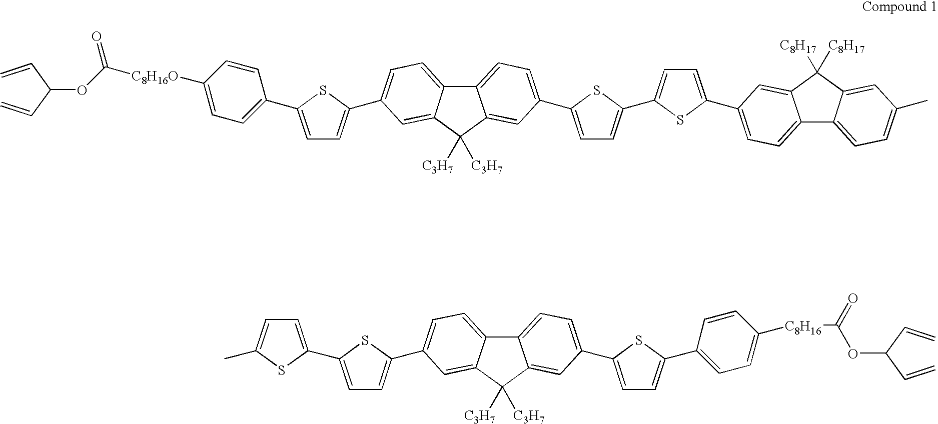
The presence of multiple 9,9-dialkyl substituted fluorene rings allows extremely long molecules with Δn value of 0.7 or greater to be used that have crystal to nematic transition temperatures of under 100° C.

The holographic film 100, 200 may also include other materials in addition to the calamitic reactive mesogen or mixture of calamitic reactive mesogen. The holographic film 100, 200 may contain a solvent soluble polymeric binder, for an example an isotropic polymeric material like poly-n-butyl acrylate or polyvinyl acetate. The polymeric binder may also be a side or main chain liquid crystal such as poly-8-(4′-{7-[5-(4-n-octyloxyphenyl)thien-2-yl]9,9-di-n-pentylfluoren-2-yl}biphenyl-4-yloxy)-n-octyl acrylate (Compound 2).

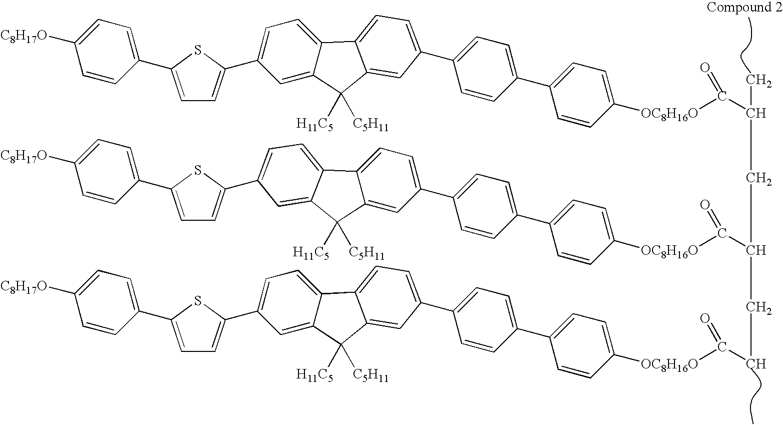

The film will also contain a photoinitiator and also an optional sensitizing dye. An example of a photoinitiator is Irgacure 184. 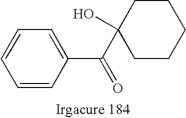
This material homolytically cleaves into two free radicals on exposure to UV light. The free radicals then initiate crosslinking of the reactive mesogen.

Photoinitiators when used alone will only be sensitive to UV light. Since the light used to write the hologram will most often be of the same wavelength as is used to reconstruct the holographic image, the combination of a photoinitiator plus a sensitizing dye that absorbs visible light will most often be used. For example, a combination of the sensitizer JAW (2,5-bis[(2,3,6,7-tetrahydro-1H,5H-benzo[ij]quinolizin-9-yl)methylene]-cyclopentanone, available from Hampford Research in Stratford, Conn.) and the photoinitiator BCIM (2,2′-bis-(2-chlorophenyl)-4,4′,5,5′-tetraphenyl-1,2′bisimidazole, available from Jodan Technologies in Yorktown Heights, N.Y.) may be used to provide a blue sensitive holographic medium. Other photoinitiator-sensitizer dye combinations as are well known in the field may be used to produce visible light sensitive formulations. Dye sensitized photopolymerization and useful photosensitizer-dye combinations are discussed in “Dye Sensitized Polymerization” by D. F. Eaton in Advances in Photochemistry, Volume 13, Wiley-Interscience, which is incorporated herein by reference.

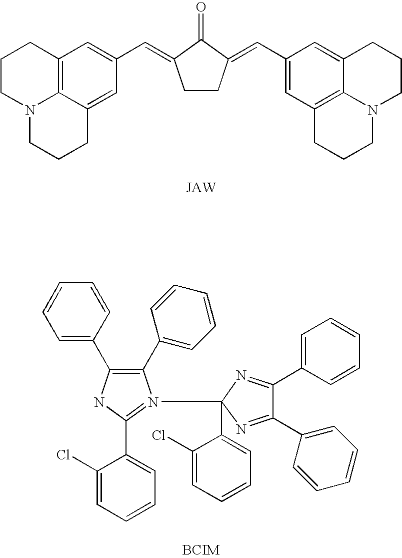

The sensitizer dye doped into the liquid crystal host phase of the calamitic layer 102 should have the additional property that it may be bleached by exposure to light (generally UV light) of a wavelength not used for the holographic exposure. This allows the holographic film to be rendered transparent after the process of forming the holographic image.

The formulation of the holographic film may also contain an isotropic plasticizer or diluent. As an example a small amount of dibutyl phthalate may be added to the formulation so long as the addition does not significantly reduce the order parameter of the liquid crystalline phase in the calamitic layer 102. As will be seen below, the addition of an isotropic additive may be useful in controlling the polarization state of light emanating from the reconstructed holographic image when a hologram produced from the film is illuminated.

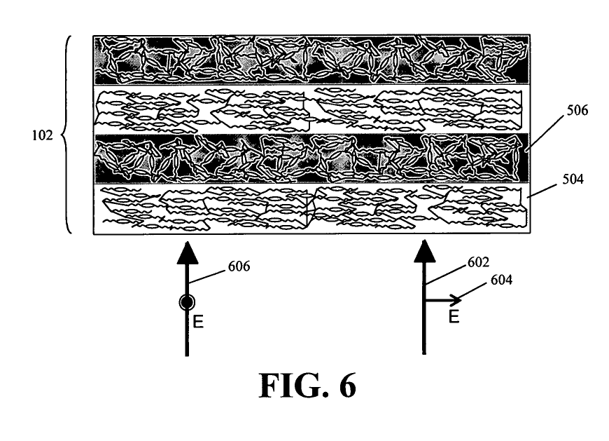

FIG. 6 illustrates the alignment of the molecular cores of a crosslinked reactive mesogen in a holographic film 100, 200 of the invention that has been used to record a plane wave hologram. Light 602 that is polarized in the plane of the figure passes into the calamitic layer 102. Since the electric vector 604 of this light is parallel to the long molecular axes of the reactive mesogen molecular cores in a region 404 that were exposed high light intensity in the holographic exposure, incident polarized light sees the extraordinary refractive index of the uniaxial birefringent medium in this region. Upon passing into a region 506 that was exposed to a low intensity of light during the holographic exposure the orientation of molecular cores is isotropic at least in the plane of the device and the light sees a refractive index that is some weighted average of the extraordinary and ordinary refractive indices of the polymerized reactive mesogen. The exact value of the refractive index experienced in this region will depend on whether the heating of the reactive mesogen in step 5c above disorders the reactive mesogen sufficiently that the long axes of its molecules are in part allowed to be oriented out of the plane of the device. The value of the refractive index in this region na is likely intermediate in value between (nₑ+nₒ)/2 and (nₑ+2nₒ)/3, where nₑ is the extraordinary refractive index of the polymerized reactive mesogen and nₒ is its ordinary refractive index. Thus the light polarized in the plane of the figure sees an oscillating refractive index as it passes through the film.

Now we examine the fate of light 606 that is polarized normal to the plane of the figure. Upon entering a region corresponding to unshaded areas 504, the polarization axis of the light is perpendicular to the molecular long axes and thus the light see a refractive index equal to nₒ. On entering region 506 the light sees refractive index nₐ. Thus light 606 also sees an oscillating refractive index as it passes through the film. However, since the pitch of the interference fringes and hence of the refractive index oscillation in the calamitic layer 102 is equal to p=λₘ/2, where λₘ is the wavelength of the recording/reconstruction light, the spatial position of the holographic structure seen by light 606 is offset p/2=λₘ/4 versus the holographic structure seen by light 602. As a result both light 602 and light 606 are reflected with their polarization states unaltered, but plane polarized light with its polarization axis oriented at 45° to both light 602 and 606 is resolved into equal components of light 602 and light 606 upon reflection from the hologram and the two components are out of phase by 180°. Thus this light has its polarization angle rotated by 90°.

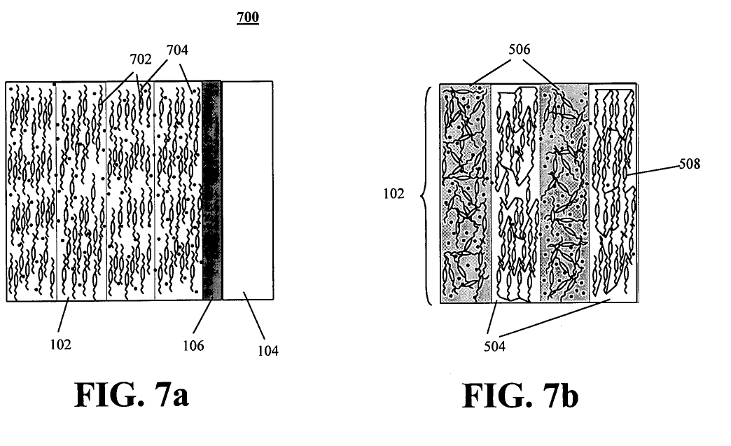

FIG. 7a illustrates a holographic reflector that reflects only one polarization of light, that is to say light 602 is reflected, but light 606 is unaffected by the holographic film layer. The holographic film 700 is prepared in the same manner as the holographic film 100 of FIG. 1 except that an optically isotropic material is mixed into the reactive mesogen material in the calamitic layer 102. The calamitic layer 102 then contains the oriented rod-shaped molecules 702 of the reactive mesogen doped with the non-rod-shaped molecules 604 of the isotropic material. Molecules 704 have no substituents that promote crosslinking and so are uninvolved in the crosslinking reaction. As can be seen in FIG. 7b, interfering light beams create an interference pattern in the calamitic layer 102 as before. The high intensity of light in the unshaded areas 504 initiates crosslinking. The crosslinking reaction converts the fluid in regions corresponding to the unshaded areas 504 into a solid matrix. This phase change expels molecules of material 704 from the unshaded areas 504 into relatively unexposed regions of the shaded areas 506. If sufficient molecules 704 are injected into regions corresponding to the shaded areas 506, the liquid crystalline to isotropic phase transition temperature will be reduced in regions of the shaded areas 506 to the point that the material in these regions will become isotropic during exposure.

Once the initial holographic exposure is completed the post-processing of the holographic film is similar that of FIG. 5. Depending on the amount of isotropic dopant transferred into unexposed regions of the shaded areas 506 during the holographic exposure it may or may not be necessary during post-processing to heat the film to convert unexposed regions of the shaded areas 506 to the isotropic phase prior to the final flood exposure.

The expulsion of the isotropic dopant from the regions corresponding to unshaded areas 504 in this embodiment resembles the PIPS (Polymerization Induced Phase Separation) process used to produce polymer dispersed liquid crystal displays (See for example: P. S. Drzaic, Liquid Crystal Dispersions (Liquid Crystals Series, Volume 1) World Scientific Publishing, 1995), which is incorporated by reference. However, in the TIPS process material with a liquid crystalline phase is expelled from an isotropic prepolymer as it undergoes polymerization. Thus the material flow in PIPS is opposite that in this invention. It is also evident that the process used in this embodiment differs from that used in the DuPont Omnidex materials in that the microscopic flow of materials in the DuPont case is driven by a concentration gradient and consequent chemical potential difference. By contrast this invention uses a phase change to drive the microscopic material flow.

A potential advantage of this alternative embodiment is that if the refractive index of the isotropic dopant 704 and its concentration are properly chosen, the refractive index na of the isotropic regions corresponding to the shaded areas 506 of the holographic film 700 can be made to be equal to the ordinary refractive index of the material in the regions corresponding to the shaded areas 504. In this case light 606 sees no refractive index modulation while passing through the holographic film 700, while light 602 sees an oscillating refractive index as before. Thus it is possible in this way to produce a holographic optical element that acts on only one polarization of light.

A seeming drawback of this embodiment is that the material transfer of the isotropic dopant during holographic exposure changes the refractive index of regions 406 in real time thus removing the latency of the holographic image during exposure. However, if the holographic exposure is conducted using plane polarized light only, this effect may be minimized. The use of light 606 is possible if the dye sensitizer used in the calamitic layer 102 of holographic film 700 is an isotropic absorber that is not aligned to yield dichroism (anisotropic absorption) when doped into the liquid crystalline host.

A potential problem with this embodiment of the invention is that if the isotropic dopant is transferred too rapidly into regions corresponding to the shaded areas 506 during the holographic exposure, the regions corresponding to the shaded areas 506 may undergo the liquid crystal to isotropic phase transition before regions corresponding to the unshaded areas 504 are sufficiently crosslinked to lock in the alignment of the liquid crystalline phase. In this case the alignment of the liquid crystalline phase in regions corresponding to the unshaded areas 504 may become random destroying the holographic recording. An approach to ameliorating this problem is use a material as the isotropic dopant that has a liquid crystalline phase with its liquid crystal to isotropic phase transition temperature below the temperature at which the holographic exposure is carried out. As an example PCH32 (trans-4-ethyl-(4-propylcyclohexyl)benzene) may be used as the isotropic dopant.

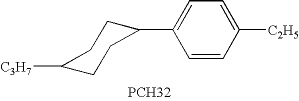

This material has a nematic to isotropic phase transition temperature considerably below 0° C. and also has a low refractive index because of the cyclohexyl ring in its structure. An additional advantage of using a dopant like PCH32 rather than a strictly isotropic material is that it is less like likely to reduce the liquid crystalline order and thus the birefringence in regions corresponding to unshaded areas 504.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

1-86. (canceled)

87. A process for recording a hologram comprising:
providing a film of liquid crystal material having uniformly aligned molecules;
exposing the film of liquid crystal material to an interference pattern of light such that areas corresponding to high light intensity in the interference pattern cause the liquid crystal material to crosslink such that a liquid crystal structure is locked into an immobile polymer matrix in the areas corresponding to high light intensity while leaving areas outside the areas corresponding to high light intensity substantially uncrosslinked;
causing the areas outside the areas corresponding to high light intensity of the film of liquid crystal material into a less ordered fluid phase; and
crosslinking the film of liquid crystal material in the areas outside the areas corresponding to high light intensity.

88. The process of claim 87, wherein the causing the areas outside the areas corresponding to high light intensity of the film of liquid crystal material into the less ordered fluid phase is performed by heating the film of liquid crystal material above a phase transition temperature between a liquid crystal phase of the liquid crystal material and the less ordered fluid phase of the liquid crystal material.

89. The process of claim 87, wherein the crosslinking the film of liquid crystal material is performed by light exposure.

90. The process of claim 87, wherein the film of liquid crystal material is supported by a transparent substrate.

91. The process of claim 87, wherein molecules of the film of liquid crystal material are uniformly aligned by an aligning layer.

92. The process of claim 91, wherein the aligning layer is a layer interposed between the liquid crystal film and a transparent substrate.

93. The process of claim 91, wherein the aligning layer is one of a rubbed polymer layer, a rubbed polyimide layer or a photoalignment layer.

94. The process of claim 91, wherein the aligning layer is a layer interposed between the film of liquid crystal material and an overlaid transparent cover sheet.

95. The process of claim 87, wherein the film of liquid crystal material is overlaid with a transparent cover sheet.

96. The process of claim 87, wherein the liquid crystal material is a nematic liquid crystal.

97. The process of claim 87, wherein the liquid crystal material is a smectic liquid crystal.

98. The process of claim 87, wherein the less ordered fluid phase is a nematic phase.

99. The process of claim 87, wherein the less ordered fluid phase is an isotropic liquid phase.

100. The process of claim 87, wherein the film of liquid crystal material further comprises a polymeric binder.

101. The process of claim 100, wherein the polymeric binder has a liquid crystalline structure.

102. The process of claim 100, wherein the polymeric binder has a non-liquid crystalline structure.

103. The process of claim 87, wherein the film of liquid crystal material includes a low molecular weight diluent.

104. The process of claim 103, wherein the low molecular weight diluent is an optically isotropic material.

105. The process of claim 103, wherein the low molecular weight diluent has a liquid crystalline structure.

106. The process of claim 103, wherein the low molecular weight diluent is thermally crosslinkable.

107. The process of claim 106, wherein the low molecular weight diluent is thermally crosslinked after exposing the film of liquid crystal material to the interference pattern.

108. The process of claim 103, wherein the low molecular weight diluent has a monotropic liquid crystal to isotropic transition.

109. The process of claim 103, wherein the low molecular weight diluent has a liquid crystal to isotropic transition at a temperature below a temperature at which light exposure is used to produce the holographic optical element.

110. The process of claim 103, wherein the low molecular weight diluent migrates from the areas corresponding to high light intensity into areas outside the areas corresponding to high light intensity during the exposing the film of liquid crystal material to the interference pattern.

111. The process of claim 110, wherein the migration of the low molecular weight diluent lowers the refractive index of areas of the film of liquid crystal material into which the low molecular weight diluent migrates.

112. The process of claim 110, wherein the migration of the low molecular weight diluent lowers a refractive index of the areas outside the areas corresponding to high light intensity such a refractive index of the areas outside the areas corresponding to high light intensity is equal to an ordinary refractive index of the liquid crystal material that is crosslinked while exposing the film of liquid crystal material to an interference pattern.

113. The process of claim 87, wherein the uniform alignment of the film of liquid crystal material is a homogenous alignment.

114. The process of claim 87, wherein the uniform alignment of the film of liquid crystal material is a homogenous alignment in the plane of the film.

115. The process of claim 87, wherein the uniform alignment of the film of liquid crystal material is homeotropic alignment.

116. The process of claim 87, wherein the film of liquid crystal material that is polymerized has the molecular structure B-S-A-S-B
wherein A is a chromophore; S is a spacer; and B is a photocrosslinkable end group.

117. The process of claim 116, wherein photocrosslinkable end group B is selected from the group consisting of:

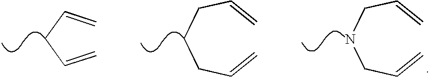

118. The process of claim 116, wherein photocrosslinkable end group B is selected from acrylate or methacrylate.

119. The process of claim 116, wherein spacer groups S independently comprise branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms.

120. The process of claim 116, wherein
A is a chromophore of general formula —(Ar-Fl)ₙ-Ar—
wherein
Ar is an aromatic diradical or a heteroaromatic diradical bonded linearly or substantially linearly to adjoining diradicals, or a single bond;
Fl is a 9,9-dialkyl substituted fluorene diradical joined to adjoining diradicals at the 2 and 7 positions; and
the Ar and Fl diradicals may be chosen independently in each of the n subunits of the chromophore.

121. The process of claim 87, wherein the film of liquid crystal material that is polymerized has a birefringence value (Δn) greater than 0.2.

122. The process of claim 87, wherein the film of liquid crystal material that is polymerized has a birefringence value (Δn) greater than 0.5.

123. The process of claim 87, wherein the reference beam that is interfered with the image beam is a plane wave beam.

124. The process of claim 87, wherein the image beam that is interfered with the reference beam is a plane wave beam.

125. The process of claim 87, wherein the interference pattern is formed by an image beam and a reference beam.
